(19) United States
(12) Patent Application Publication
(10) Pub. No.: US 2008/0188268 A1
(43) Pub. Date: Aug. 7, 2008

(54) Mobile communication terminal and method of operating the same

(75) Inventors: Tae Hun Kim, Inchun-si (KR); Se Hoon Jang, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/797,171

(22) Filed: May 1, 2007

(30) Foreign Application Priority Data
Feb. 3, 2007 (KR) 10-2007-0011290

(51) Int. Cl. H04M 1/00

(52) U.S. Cl. 455/566

(57) ABSTRACT

A mobile communication terminal including at least one side key, a display unit including a touch screen and a controller configured to display on the display unit an interface screen when the at least one side key is manipulated, said interface screen including selectable items for setting at least one of a receiving call alert mode of the terminal and a button alert mode of the terminal.

This application claims priority to Korean Application No. 2007-11290, filed in Korea on Feb. 3, 2007, the disclosure of which is incorporated herein by reference.

### BACKGROUND OF THE INVENTION

1. Field of the Invention

The present invention relates to a mobile communication terminal and a method of operating the same in which a display screen is provided allowing a user to set an incoming call alert mode and/or a button alert mode via a simple key manipulation.

2. Description of the Related Art

A mobile communication terminal provides voice communication capabilities as well as multimedia capabilities. For example, a user can have a conversation with another party using the terminal, receive emails, play games, listen to music, watch videos, perform scheduling tasks, take pictures, etc. Thus, there are several different functions that may be performed using the mobile terminal.

As the number of functions provided by the terminal has increased, the menu options on the terminal have also increased. That is, the menu options are related to setting different features of each function. For example, the user can send a text message using a corresponding text message menu (e.g., by selecting a main menu, selecting a text message sub-menu and selecting a create text message sub-menu).

The mobile terminal also provides a variety of different ring tones, for example, that the user may assign to each caller in a call list. For example, a user may set a different ring tone for his or her mother, father, friend, etc. The user can also set a speaker volume for the ring tones or a voice volume of the terminal using the main menu and sub-menus provided with the terminal.

For example, the user can change or set the volume of the speaker by selecting a main menu, selecting a mobile terminal environment or settings sub-menu, selecting the speaker volume sub-menu, and then finally inputting a desired level of the speaker volume. Thus, the user has to select several different menus to change or set the volume.

### SUMMARY OF THE INVENTION

Accordingly, one object of the present invention is to address the above-noted other problems.

Another object of the present invention is to provide a mobile communication terminal and a method of operating the same in which a user of the mobile communication terminal can set an incoming call alert mode and/or a button alert mode and/or a button alert mode of the mobile terminal through a simple key manipulation.

To achieve these and other advantages and in accordance with the purpose of the present invention, as embodied and broadly described herein, the present invention provides in one aspect a mobile communication terminal including at least one side key, a display unit including a touch screen, and a controller configured to display on the display unit an interface screen when the at least one side key is manipulated, said interface screen including selectable items for setting at least one of a receiving call alert mode of the terminal and a button alert mode of the terminal.

In another aspect, the present invention provides a method of controlling a mobile communication terminal. The method includes displaying an interface screen on a touch screen of the terminal when at least one side key is manipulated, in which the interface screen includes selectable items for setting at least one of a receiving calling alert mode of the terminal and a button alert mode on the terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein;

FIG. 1 is a block diagram illustrating a mobile communication terminal according to an embodiment of the present invention;

FIG. 2 is a front view of a mobile communication terminal according to an embodiment of the present invention;

FIG. 3 is a perspective view of a mobile communication terminal according to an embodiment of the present invention;

FIG. 4(a) is a diagram illustrating an idle screen displayed on a touch screen of a mobile communication terminal according to an embodiment of the present invention;

FIG. 4(b) is a diagram illustrating a bell sound adjust display screen according to an embodiment of the present invention;

FIG. 5(a) is a diagram illustrating a vibration level adjustment display screen according to an embodiment of the present invention;

FIG. 5(b) is a diagram illustrating a maximum bell and vibration setting display screen according to an embodiment of the present invention;

FIG. 5(c) is a diagram illustrating a manner mode setting display screen according to an embodiment of the present invention;

FIG. 5(d) is a diagram illustrating a button sound level adjustment display screen according to an embodiment of the present invention;

FIGS. 6(a) and 6(b) are diagrams illustrating a bell sound level adjustment display screen according to another embodiment of the present invention; and

FIG. 7 is a flowchart illustrating an operation of a mobile communication terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

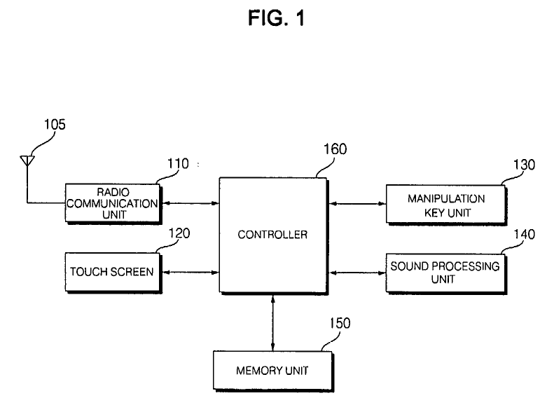

Turning first to FIG. 1, which is a block diagram illustrating a mobile communication terminal according to an embodiment of the present invention. As shown, the mobile terminal includes a radio communication unit 110 connected to an antenna 105 to transmit and receive a wireless signal in a communication system. The terminal also includes a controller 160 for controlling the overall operations of the mobile communication terminal.

In more detail, the controller 160 processes a signal received through the radio communication unit 110 and performs various services such as voice communication by transmitting a signal corresponding to the received signal through the radio communication unit 110. In addition, the radio communication unit 110 can be configured to transmit and receive a wireless signal according to different standards based on a particular provider or based an area in which the mobile communication terminal is used.

Further, as shown in FIG. 1, the mobile terminal also includes a manipulation key unit 130 that a user can use for inputting information into the mobile communication terminal. A memory unit 150 is also provided for storing data such as software applications used for driving the terminal. The memory unit 150 also stores user-created information such as a phone book list or a memo that is input by the user of the terminal.

Further, the manipulation key unit 130 includes a keypad, roller key, etc. that is used by the user to enter information into the terminal. As shown in FIG. 1, the mobile terminal also includes a touch screen 120 for inputting information such as an instruction into the terminal in addition to the manipulation key unit 130. In addition, the touch screen 120 also functions as a display for the terminal. Therefore, the user can input information/instructions, can select menu options, etc. and can also view information related to a status of the terminal on the touch screen 120.

The touch screen 120 can be used in combination with the key unit 130 or the touch screen 120 can be solely used to enter information. In the latter instance, the key unit 130 does not need to be included in the mobile terminal. A sound processor 140 is also included in the terminal and outputs different sounds (e.g., ringtones, alarms, a caller's voice, music, etc.) through a speaker included with the terminal.

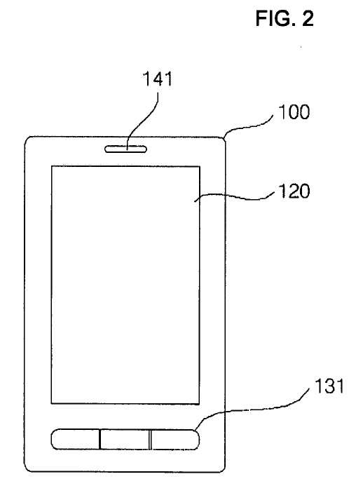

Turning next to FIG. 2, which is front view of a mobile terminal 100 according to an embodiment of the present invention. As shown in FIG. 2, the terminal 100 includes the touch screen 120 discussed above with respect to FIG. 1 and a speaker 141. The terminal 100 also includes a key input unit 131 for inputting information into the terminal 100 at a lower end of the touch screen 120. Thus, the user can input a suitable instruction into to the terminal 100 using both the key input unit 131 and the touch screen 120.

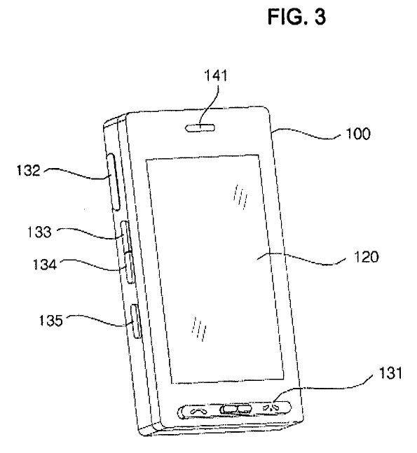

Next, FIG. 3 is a perspective view of the terminal 100 shown in FIG. 2 according to an embodiment of the present invention. As shown in FIG. 3, the terminal 100 also includes a plurality of side keys 132 to 135 in addition to the key input unit 131. In this example, four side keys 132 to 135 are provided. However, any number of side keys may be provided. The side keys 132 to 135 may also be provided at any location on the terminal 100.

Further, in one example, the side keys 133 and 134 are used for displaying menu selectable items allowing the user to set or change an incoming call alert mode such as level of a bell sound (e.g., ringtone, etc.), vibration level, etc. and a button alert mode such as a sound or vibration level when a button on the terminal is selected.

In addition, the incoming call alert mode corresponds to how the user is notified about an incoming call. For example, the user may be notified via a ringtone, a bell sound, vibration, etc. Similarly, the button alert mode corresponds to what happens when the user selects a button on the terminal. For example, the terminal may vibrate when a button is selected, a particular sound may be emitted through the speaker 141, and/or lights may flash on the terminal.

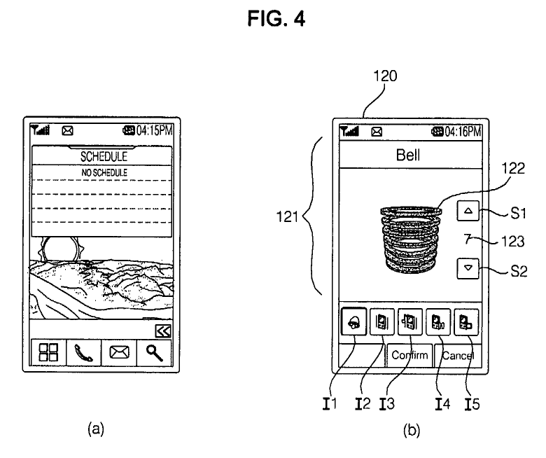

Turning next to FIG. 4(b), which illustrates a bell sound adjustment menu displayed on the touch screen 120 when one of the side keys 133 or 134 is selected from an idle state shown in FIG. 4(a). In more detail, the controller 160 controls the touch screen 120 to display a display interface screen 121 when one of the keys 133 or 134 is selected. As shown, the display screen 121 includes a plurality of different items that a user can select to set or change the incoming call alert and button alert modes. For example, the display screen 121 includes a graphic 122 representing a volume level, soft keys S1 and S2, a current volume indicator 123 and a plurality of selectable icons 11 to 15.

The icons 11 to 15 allow the user to select several different display screens including menus related to setting the incoming call alert mode and button alert mode. Therefore, when the user selects a particular icon 11 to 15, the controller 160 controls the display 120 to display a display screen 121 corresponding to the selected icon. As shown in FIG. 4(b), the display 120 also includes a confirm and cancel key allowing the user to confirm or cancel an operation, respectively.

Further, the controller 160 displays the soft keys S1 and S2 on the display screen 121 allowing the user to adjust a level of the incoming call alert and button alert modes. For example, the user can touch the soft key S1 to increase the volume level and select the soft key S2 to decrease the volume level. The user may also increase or decrease the volume level using the side keys 133 and 134.

In addition, if the display 120 is not a touch screen, the user can manipulate the soft keys S1 and S2 using the corresponding side keys 133 and 134 to increase or decrease the volume level. Further, the icons 11 to 15 may be selected using vertical and horizontal direction keys provided on a keypad included with the terminal. When the display is a touch screen, the user may simply touch a corresponding icon.

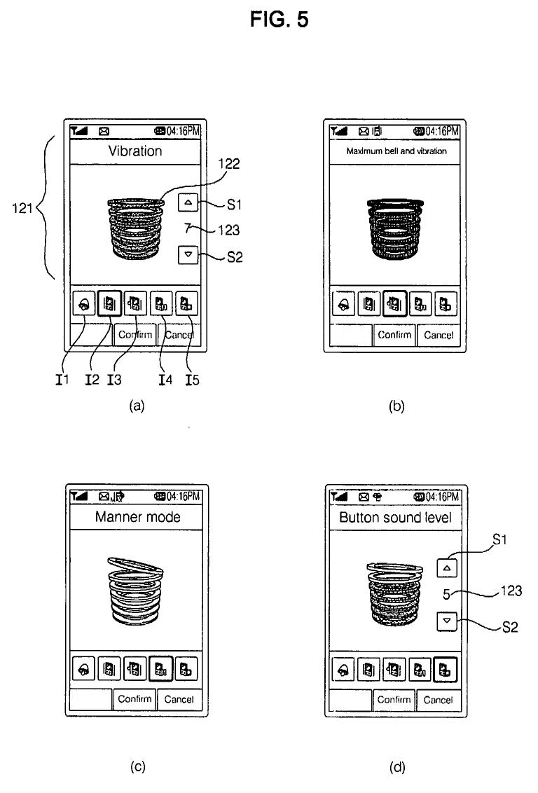

Turning next to FIG. 5(a), which is a diagram illustrating the display screen 121 for changing or setting the vibration level of the terminal. That is, the call alert mode is set as a vibration mode. As shown in FIG. 5(a) (and FIG. 4(b)), the display screen 121 includes a label on a top portion thereof indicating what menu has been selected. Thus, when the user selects the second icon 12, the controller 160 controls the display 120 to display the display screen 121 shown in FIG. 5(a).

FIGS. 5(b), 5(c) and 5(d) are diagrams illustrating display screens when the user selects the icons 13, 14 and 15, respectively. In more detail, and as shown in FIG. 5(b), when the user selects the third icon 13, an interface display screen for setting the incoming call alert mode to a maximum bell and vibration is displayed. Further, as shown in FIG. 5(c), when the user selects the icon 14, an interface display screen for setting the incoming call alert mode to be a manner mode is displayed. The manner mode in one example corresponds to the terminal flashing and vibrating when a call is received.

For example, backlights for each key may be flashed on and off. The touch screen may also be flashed on an off. That is, the entire area of the touch screen may be flashed on and off, or small portions of the touch screen may be sequentially turned on and off to give the appearance of the terminal flashing on and off. Thus, when the user selects the manner mode, he or she is setting the terminal to vibrate and flash lights when a call is received.

In addition, as shown in FIG. 5(d), when the user selects the icon 15, a display interface screen for adjusting a button sound level is displayed. That is, the icon 15 corresponds to the button sound alert mode. Thus, the user can set or change a button alert characteristic by using this menu. For example, when the button alert mode is set to a sound being emitted when a button is pressed, the user can increase or decrease the volume of the sound using the soft keys S1 and S2. The same applies to setting a level of vibration for the button alert mode.

In addition, for the maximum bell and vibration display screen shown in FIG. 4(b), the soft keys S1 and S2 are not displayed, because there is only one setting (i.e., a maximum setting). The same is true with the manner mode display screen shown in FIG. 4(c). However, the soft keys S1 and S2 are displayed in the menus for adjusting the bell sound, the vibration level and the button alert mode as shown in FIGS. 5(a), 5(b) and 5(d).

Further, because the display unit of the mobile terminal 100 includes the touch screen 120, the user can input an instruction into the terminal 100 through the soft keys S1 and S2. The user can also adjust the sound level using the side keys 133 and 134. In addition, the user can also view the graphic 122 on the display screen 121 to determine the current sound level or vibration level, because the color or shape of the graphic 122 is changed to reflect the current sound or vibration level. For example, the graphic 122 in FIG. 5(a) is completely filled in and the graphic 122 in FIG. 5(d) is partially filled in indicating the current level of the sound or vibration. In this instance, the current level indicator 123 can be eliminated from the display screen 121 to provide more room on the display screen 121.

In more detail, when the user sets the sound or vibration level, the controller 160 changes a color of the graphic 122, whereby the user can easily view the current sound or vibration level. In addition, when the user sets the maximum bell and vibration mode as in FIG. 5(b), the controller 160 changes the color of the graphic 122 (in this example, darkens the color) to indicate to the user that the maximum sound and vibration mode is set. A similar concept applies to the manner mode set in FIG. 5(c).

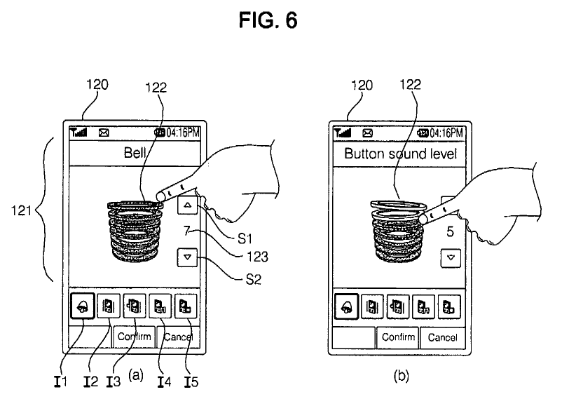

Turning next to the embodiment illustrated in FIG. 6. In this embodiment, the user touches and drags his or her finger on the touch screen 120 to automatically change the bell sound or vibration level. In more detail, as shown in FIGS. 6(a) and 6(b), the user touches the graphic 122 and drags his or her finger across the touch screen 120 to change the sound level from “7” to “5”. The user can also increase the sound level by dragging his or her finger upwards rather than downwards on the graphic 122.

Thus, in this example, the user can adjust the sound and vibration level using three different methods: 1) using the side keys 133 and 134, 2) using the soft keys S1 and S2, and 3) by dragging the graphic 122. However, when the display unit does not include the touch screen 120 and is a general Liquid Crystal Display (LCD), the user can adjust the sound and vibration level using vertical and horizontal direction keys provided in the keypad.

Note that in the examples shown in FIG. 4, the bell sound interface screen was first displayed when on of the side keys 133 or 134 are manipulated. However, any of the other interface screens (e.g., vibration, maximum sound and vibration, etc.) may be displayed first rather than the bell sound interface screen. That is, a table may be created that lists what interface screen is to be first displayed when the side key 133 or 134 is activated. The table may also be used to list an order of the interface screens such that the bell sound interface screen shown in FIG. 4(a) is displayed when the side key 133 or 134 is pressed once, the vibration interface screen shown in FIG. 4(b) is displayed when the side key 133 or 134 is pressed twice in a successive manner, etc. The controller 160 may then refer to the table to determine which interface screen to display. The list of interface screens may also be set or changed by the user using provided menu options.

Further, the side keys 133 and 134 may be linked to a particular interface screen. For example, the side key 133 may be linked to the bell sound interface screen shown in FIG. 4(a) and the side key 134 may be linked to the vibration interface screen shown in FIG. 4(b). Thus, when the user presses the side key 133, the controller 160 displays the bell sound interface screen and when the user presses the side key 134, the controller 160 displays the vibration interface screen. The user may also link these screens may also be linked to the side keys 133 and 134 by using the appropriate menu options. This is particularly advantageous because the user may find that after using the terminal for some period of time, he or she determines they use a particular interface screen more than other interface screens. Thus, in this embodiment, the user can advantageously customize the actions of the side keys 133 and 134 according to his or her preferences.

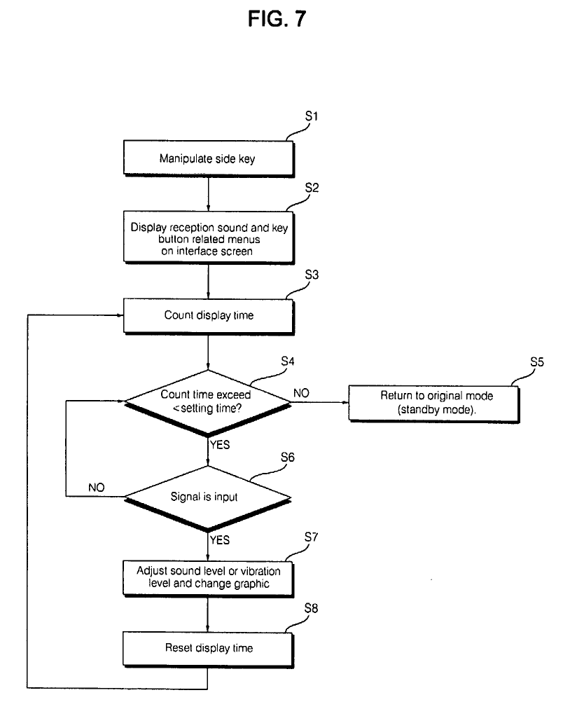

Turning next to FIG. 7, which is a flowchart illustrating an operation of a mobile communication terminal according to an embodiment of the present invention. As shown, when the side key 133 or 134 is manipulated (S1), the controller 160 displays the bell sound interface screen (or other interface screen as discussed above) on the touch screen 120 (S2) and then starts a timer to count an amount of time the interface screen is displayed (S3). The controller 160 then determines if the counted time is less than a predetermined amount of time (S4). If the counted time is less than the predetermined amount of time (Yes in S4), the controller 160 determines if the user has input an instruction into the interface screen (S6). If the counted time exceeds the predetermined amount of time (No in S4), the controller 160 sets the terminal back into the idle or standby mode (S5).

Further, if the user has not entered any additional input after the interface screen was displayed (No in S6), the process returns to step S4. The input signal may be a signal that is input through a soft key on the touch screen 120, a graphic dragging signal on the touch screen 120, or a signal through the side keys. However, if an additional signal is input into the terminal 100 (Yes in S6), the controller 160 performs the input instruction (S7) and then resets the counted display time to zero (S8).

In addition, the controller 160 can store a sound level or a vibration level of each menu before returning to the standby mode. For example, if the user does not input an additional signal during a the predetermined amount of time after manipulating the icon 13 to display the interface screen shown in FIG. 5(b), the controller can set the call reception sound to be the maximum bell and vibration mode. That is, the current value is automatically set by the user not performing an additional input for a predetermined amount of time. The predetermined amount of time may also be set and changed by the user.

Further, in the example shown in FIG. 3, the side keys 133 and 134 are formed at the middle side of the terminal 100. However, the keys 133 and 134 may be formed at any other position on the terminal, such as a top side portion, bottom side portion, etc. Further, the side keys 133 and 134 are set to display the interface screens described above when they are activated in a standby mode. However, the side keys 133 and 134 may also be set to display the interface screens when activated in any other mode such as when the user is talking on a speaker phone of the terminal and wants to increase the volume.

As described above, the user of the mobile communication terminal according to embodiments of the present invention can adjust and set a call alert mode and button alert mode through a simple side key manipulation.

This invention may be conveniently implemented using a conventional general purpose digital computer or microprocessor programmed according to the teachings of the present specification, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits whereby interconnecting an appropriate network of conventional computer circuits, as will be readily apparent to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1-26. (canceled)

27. A mobile communication terminal, comprising:
at least one side key;
a display having a touch screen; and
a controller configured to display on the display an interface screen having a selection item when the side key is pressed, said selection item being selectable to set a corresponding one of a call receiving mode and a key button mode on the terminal,
wherein the controller is further configured to, when the selection item is selected, display a volume level or a vibration intensity for the corresponding one of the call receiving mode and the key button mode using a graphic, and to adjust the volume level or the vibration intensity for the corresponding one of the call receiving mode and the key button mode as the graphic is dragged on the touch screen.

28. A method of controlling a mobile communication terminal having a display including a touch screen, the method comprising:
displaying on the display an interface screen having a selection item when a side key on the terminal is pressed, said selection item being selectable to set a corresponding one of a receiving mode and a key button mode on the terminal;
displaying, when the selection item is selected, a volume level or a vibration intensity for the corresponding one of the call receiving mode and the key button mode using a graphic; and
adjusting the volume level or the vibration intensity for the corresponding one of the call receiving mode and the key button mode as the graphic is dragged on the touch screen.

29. A mobile communication terminal, comprising:
at least one side key;
a display having a touch screen; and
a controller configured to, when the side key is pressed, display on the display an interface screen having a selection item, said selection item being selectable to set a corresponding one of a call receiving mode and a key button mode on the terminal,
wherein the selection item is an icon corresponding to a menu used to set the corresponding one of the call receiving mode and the key button mode, and
wherein the controller is further configured to display a graphic indicating at least one of a volume level and a vibration intensity of the corresponding one of the call receiving mode and the key button mode in the menu on the interface screen, and to change a color of the graphic when said at least one of the volume level and the vibration intensity in the menu is set to a maximum value.

30. The mobile communication terminal of claim 29, wherein the menu comprises a display screen corresponding to the selected icon.

31. The mobile communication terminal of claim 29, wherein the controller is further configured to adjust said at least one of the volume level and the vibration intensity of the corresponding one of the call receiving mode and the key button mode as the graphic is dragged on the touch screen.

32. The mobile communication terminal of claim 29, wherein the controller is further configured to display at least one soft key on the menu used to set the corresponding one of the call receiving mode or the key button mode, and to adjust at least one of the volume level and the vibration intensity of the corresponding one of the call receiving mode and the key button mode based on manipulation of the soft key.

33. The mobile communication terminal of claim 29, wherein the menu is any one of a ring tone volume adjustment menu, a vibration intensity adjustment menu, a button sound volume adjustment menu, a maximum ring tone volume and vibration intensity setup menu, and a manner mode setup menu.

34. The mobile communication terminal of claim 29, wherein the controller is further configured to display the interface screen when the mobile communication terminal is in a standby mode.

35. The mobile communication terminal of claim 29, wherein the controller is further configured to store a current state displayed on the display as a state of the receiving mode or the key button mode when time lapses without receiving any command after the interface screen has been displayed on the display.

36. The mobile communication terminal of claim 29, wherein the controller is further configured to display a standby mode screen on the display when time lapses without receiving any command after the interface screen has been displayed on the display.

37. A method of controlling a mobile communication terminal having a display including a touch screen, the method comprising:
displaying, when a side key on the terminal is pressed, an interface screen having a selection item, said selection item being selectable to set a corresponding one of a call receiving mode and a key button mode on the terminal, wherein the selection item is an icon corresponding to a menu used to set the corresponding one of the call receiving mode and the key button mode; and
displaying a graphic indicating at least one of a volume level and a vibration intensity of the corresponding one of the call receiving mode and the key button mode in the menu on the interface screen, and to change a color of the graphic when said at least one of the volume level and the vibration intensity in the menu is set to a maximum value.

38. The method of claim 37, wherein the displayed menu includes a menu screen corresponding to the selected icon.

39. The method of claim 37, further comprising:
adjusting the volume level or the vibration intensity as the graphic is dragged on the touch screen.

40. The method of claim 37, further comprising:
displaying a soft key on the interface screen, the soft key being used to adjust the volume level or the vibration intensity of the corresponding one of the call receiving mode and the key button mode.

41. The method of claim 37, wherein the menu is any one of a ring tone volume adjustment menu, a vibration intensity adjustment menu, a button sound volume adjustment menu, a maximum ring tone volume and vibration intensity setup menu, and a manner mode setup menu.

42. The method of claim 37, wherein the step of displaying the interface screen includes displaying the interface screen when the mobile communication terminal is in a standby mode.

43. The method of claim 42, further comprising:
storing a current state displayed on the display as a state of the receiving mode or the key button mode when time lapses without receiving any command after the interface screen has been displayed on the display.

44. The method of claim 42, further comprising:
displaying a standby mode screen on the display when time lapses without receiving any command after the interface screen has been displayed on the display.
